(19) United States
(12) Patent Application Publication
(10) Pub. No.: US 2007/0085773 A1
(43) Pub. Date: Apr. 19, 2007

(54) Plasma display apparatus

(75) Inventor: Seonghak Moon, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 11/580,130

(22) Filed: Oct. 13, 2006

(30) Foreign Application Priority Data
Oct. 14, 2005 (JP) 10-2005-0097239

(51) Int. Cl. G09G 3/28

(52) U.S. Cl. 345/67

(57) ABSTRACT

A plasma display apparatus is disclosed. The plasma display apparatus includes a plasma display panel, a first driver, and a second driver. The plasma display panel includes a sustaining electrode and a data electrode intersecting the sustaining electrode. The first driver supplies a positive sustain pulse and a negative sustain pulse to the sustaining electrode in a sustain period. The second driver supplies a positive voltage to the data electrode prior to an application point of time of the positive sustain pulse.

This Nonprovisional application claims priority under 35 U.S.C. § 119(a) on Patent Application No. 10-2005-0097239 filed in Korea on Oct. 14, 2006 the entire contents of which are hereby incorporated by reference.

### BACKGROUND

1. Field

This document relates to a display apparatus and, more particularly, to a plasma display apparatus.

2. Discussion of Related Art

In general, a plasma display panel has a front panel and a rear panel. A barrier rib formed between the front panel and the rear panel forms a unit discharge cell. Each cell is filled with an inert gas containing a primary discharge gas, such as neon (Ne), helium (He) or a mixed gas of Ne+He, and a small amount of xenon (Xe). A plurality of the unit cells form one pixel. For example, a red (R) cell, a green (G) cell, and a blue (B) cell form one pixel.

If the unit discharge cell is discharged by applying it with a high frequency voltage, it generates vacuum ultraviolet rays, which excite phosphors formed between the barrier ribs, thereby implementing images.

The plasma display panel comprises a plurality of electrodes, for example, a scan electrode Y, a sustain electrode Z, and a data electrode X. A driver for supplying a driving voltage to the electrodes of the plasma display panel is connected to each electrode, thus forming a plasma display apparatus.

When the plasma display panel is driven, the respective drivers supply driving pulses to the electrodes of the plasma display panel in predetermined periods (for example, a reset pulse in a reset period, a scan pulse in an address period, and a sustain pulse in a sustain period), thereby implementing an image. The plasma display apparatus constructed above can be made thin and light, and has thus been in the spotlight as the next-generation display devices.

Meanwhile, in the related are plasma display apparatus that is driven as described above, image sticking in which factors affecting discharge, such as phosphors, are adhered is generated. This will be described below with reference to FIG. 1.

FIG. 1 is a view illustrating image retention occurring in a conventional plasma display panel.

Referring to FIG. 1, a discharge is locally generated at a predetermined region 12 of a panel display surface 10, as shown in (a). If the discharge of the predetermined region 12 is stopped or is replaced with a discharge of another pattern, i.e., another image as shown in (b), a problem arises because image retention appears in the above region 12 in a next image.

The image retention becomes more profound when the same screen continues or variation in the screen is insignificant, causing the image sticking. For example, when the variation ratio of continuously incoming picture data is zero or is lower than a critical change ration, the sustain pulse is applied to the same or similar region of the panel display surface in the same or similar pattern form. The adherence of the factors affecting the discharge, such as phosphors, becomes more profound and, therefore, an image implemented accordingly is further fixed. Accordingly, the image sticking in which image retention appearing in a next image is deepened is generated.

Furthermore, if lots of wall charges are generated at portions corresponding to phosphors at the time of a sustain discharge for displaying an image, the phosphors are damaged to further deepen the image sticking. In particular, positive ions heavier than electrons excite phosphors more strongly. For example, if a sustain pulse having a positive voltage level is applied to electrodes opposite to the phosphors, heavy positive ions are further attracted toward the phosphors. Accordingly, there are problems in which the phosphors are damaged and the image sticking becomes further worse.

### SUMMARY

In one aspect, a plasma display apparatus comprises a plasma display panel comprising a sustaining electrode and a data electrode intersecting the sustaining electrode, a first driver for supplying a positive sustain pulse and a negative sustain pulse to the sustaining electrode in a sustain period, and a second driver for supplying a positive voltage to the data electrode prior to an application point of time of the positive sustain pulse.

In another aspect, a plasma display apparatus comprises a plasma display panel comprising a sustaining electrode and a data electrode intersecting the sustaining electrode, a first driver for supplying a positive sustain pulse and a negative sustain pulse to the sustaining electrode in a sustain period, and a second driver for supplying a positive voltage to the data electrode prior to an application point of time of the positive sustain pulse, and stopping the application of the positive voltage to the data electrode at an application point of time of the positive sustain pulse or prior to an application point of the positive sustain pulse time.

In still another aspect, a plasma display apparatus comprises a plasma display panel comprising a sustaining electrode and a data electrode intersecting the sustaining electrode, a first driver for supplying a positive sustain pulse and a negative sustain pulse to the sustaining electrode in a sustain period, and a second driver for supplying a positive voltage to the data electrode prior to an application point of time of the positive sustain pulse, and stopping the application of the positive voltage while the positive sustain pulse is sustained at a sustain voltage.

### BRIEF DESCRIPTION OF THE DRAWINGS

The accompany drawings, which are included to provide a further understanding of the invention and are incorporated on and constitute a part of this specification illustrate embodiments of the invention and together with the description serve to explain the principles of the invention.

FIG. 1 is a view illustrating image retention occurring in a related art plasma display panel;

FIG. 2 is a block diagram showing an example of a plasma display apparatus according to an embodiment of the present invention;

FIG. 3 is a perspective view illustrating an example of a plasma display panel structure according to an embodiment of the present invention;

FIG. 4 is a view illustrating a method of implementing image gray levels of the plasma display apparatus according to an embodiment of the present invention; and

FIGS. 5 to 8 illustrate first to fourth embodiments of a driving waveform in a method of driving the plasma display apparatus according to an embodiment of the present invention.

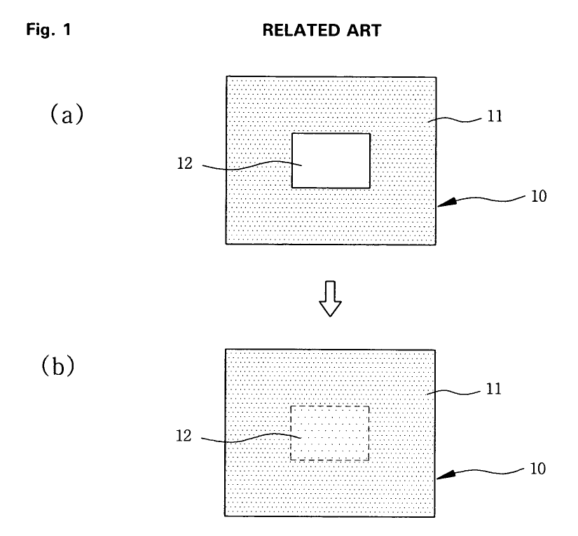

### DETAILED DESCRIPTION OF PREFERRED EMBODIMENTS

Specific embodiments of the present invention will be described in a more detailed manner with reference to the drawings.

A plasma display apparatus comprises a plasma display panel comprising a sustaining electrode and a data electrode intersecting the sustaining electrode, a first driver for supplying a positive sustain pulse and a negative sustain pulse to the sustaining electrode in a sustain period, and a second driver for supplying a positive voltage to the data electrode prior to an application point of time of the positive sustain pulse.

The sustaining electrode may comprise either a scan electrode or a sustain electrode.

The first driver may cause a ground level voltage to be sustained in either the scan electrode or the sustain electrode, to which the positive sustain pulse and the negative sustain pulse are not applied in the sustain period.

The second driver may sustain the positive voltage, which is applied to the data electrode, at a predetermined voltage level during the sustain period.

The first driver may supply a negative reset pulse to the sustaining electrode in a reset period.

The second driver may supply the positive voltage to the data electrode while the negative reset pulse is supplied to the sustaining electrode.

The first driver may supply a positive narrow-width pulse to the sustaining electrode prior to an address period after the negative reset pulse is supplied.

A plasma display apparatus comprises a plasma display panel comprising a sustaining electrode and a data electrode intersecting the sustaining electrode, a first driver for supplying a positive sustain pulse and a negative sustain pulse to the sustaining electrode in a sustain period, and a second driver for supplying a positive voltage to the data electrode prior to an application point of time of the positive sustain pulse, and stopping the application of the positive voltage to the data electrode at an application point of time of the positive sustain pulse or prior to an application point of the positive sustain pulse time.

The sustaining electrode may comprise either a scan electrode or a sustain electrode.

The first driver may cause a ground level voltage to be sustained in either the scan electrode or the sustain electrode, to which the positive sustain pulse and the negative sustain pulse are not applied in the sustain period.

The first driver may supply a negative reset pulse to the sustaining electrode in a reset period.

The second driver may supply the positive voltage to the data electrode while the negative reset pulse is supplied to the sustaining electrode.

The first driver may supply a positive narrow-width pulse to the sustaining electrode prior to an address period after the negative reset pulse is supplied.

A plasma display apparatus comprises a plasma display panel comprising a sustaining electrode and a data electrode intersecting the sustaining electrode, a first driver for supplying a positive sustain pulse and a negative sustain pulse to the sustaining electrode in a sustain period, and a second driver for supplying a positive voltage to the data electrode prior to an application point of time of the positive sustain pulse, and stopping the application of the positive voltage while the positive sustain pulse is sustained at a sustain voltage.

The second driver may cause the positive voltage, which is applied to the data electrode, to rise at a predetermined slope.

The sustaining electrode may comprise either a scan electrode or a sustain electrode.

The first driver may cause a ground level voltage to be sustained in either the scan electrode and the sustain electrode, to which the positive sustain pulse and the negative sustain pulse are not applied in the sustain period.

The first driver may supply a negative reset pulse to the sustaining electrode in a reset period.

The second driver may supply the positive voltage to the data electrode while the negative reset pulse is supplied to the sustaining electrode.

The first driver may supply a positive narrow-width pulse to the sustaining electrode prior to an address period after the negative reset pulse is supplied.

Hereinafter, exemplary implementations will be described in detail with reference to the attached drawings.

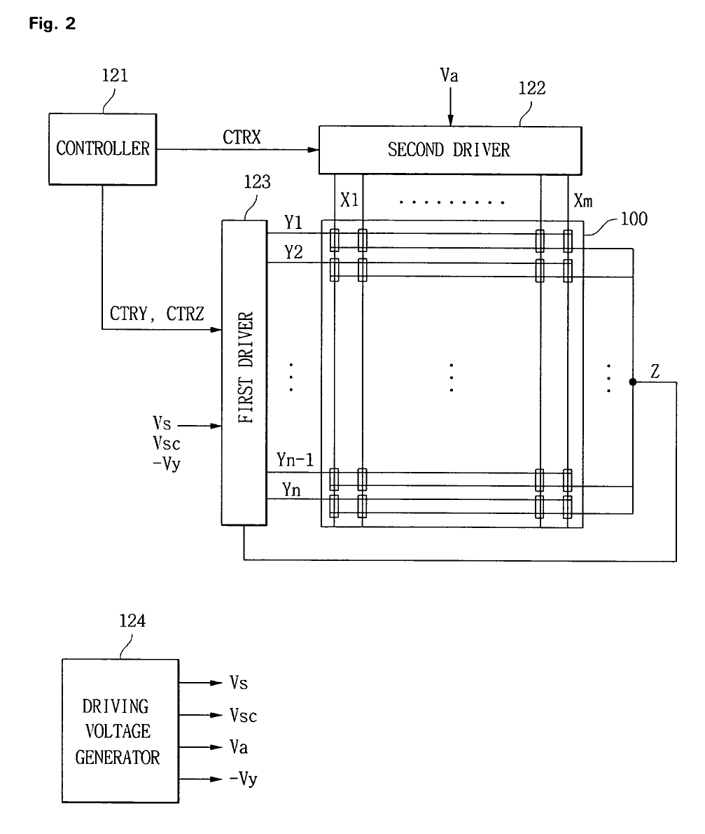

FIG. 2 is a block diagram showing an example of a plasma display apparatus according to an embodiment of the present invention.

Referring to FIG. 2, the plasma display apparatus according to an embodiment of the present invention comprises a plasma display panel 100, a first driver 123 for driving scan electrodes Y1 to Yn or a sustain electrode Z (i.e., sustaining electrodes) of the plasma display panel 100, a second driver 122 for supplying data to data electrodes X1 to Xm of the plasma display panel 100, a controller 121 for controlling the first driver 123 and the second driver 122 when the plasma display panel operates, and a driving voltage generator 124 for supplying necessary driving voltages to the respective drivers 122 and 123.

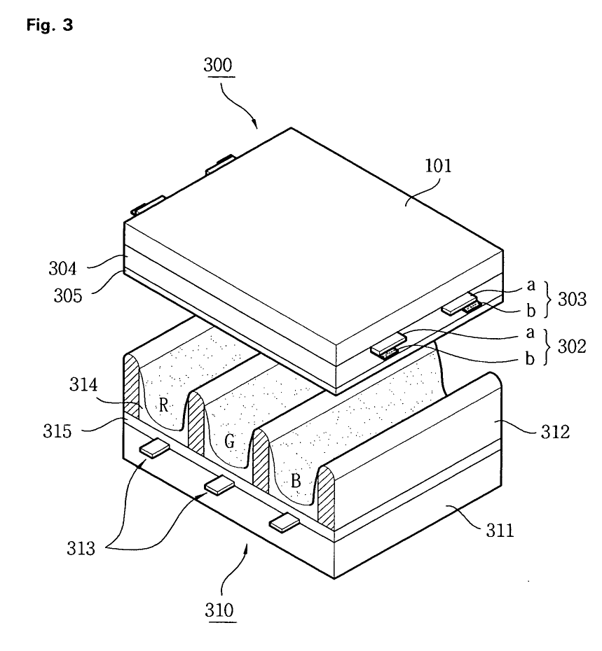

The plasma display panel 100 comprises a front substrate (not shown) and a rear substrate (not shown), which are coalesced together at a predetermined gap therebetween. A plurality of electrodes, such as the scan electrodes Y1 to Yn and the sustain electrode Z (i.e., the sustaining electrodes), are formed in pairs in the front substrate. The data electrodes X1 to Xm intersecting the scan electrodes Y1 to Yn and the sustain electrode Z are formed in the rear substrate. The construction of the plasma display panel will be described in detail below with reference to FIG. 3.

FIG. 3 is a perspective view illustrating an example of the plasma display panel structure according to an embodiment of the present invention.

Referring to FIG. 3, the plasma display panel 100 according to an embodiment of the present invention comprises a front panel 300 and a rear panel 310. In the front panel 300, a plurality of sustaining electrode pairs in which a scan electrode 302, Y and a sustain electrode 303, Z are formed in pairs is arranged on a front substrate 301 serving as a display surface on which images are displayed. In the rear panel 310, a plurality of data electrodes 313, X intersecting the plurality of sustaining electrode pairs are arranged on a rear substrate 311 serving as a rear surface. The front panel 300 and the rear panel 310 are parallel to each other with a predetermined distance therebetween.

The front panel 300 comprises the pairs of the scan electrode 302, Y and the sustain electrode 303, Z, which mutually discharge the other and sustain the emission of a cell within one discharge cell. In other words, each of the scan electrode 302, Y and the scan electrode 303, Z comprises a transparent electrode (a) formed of a transparent ITO material and a bus electrode (b) formed of a metal material. The scan electrode 302, Y and the sustain electrode 303, Z are covered with one or more dielectric layers 304 for limiting a discharge current and providing insulation among the electrode pairs. A protection layer 305 having Magnesium Oxide (MgO) deposited thereon is formed on the dielectric layers 304 so as to facilitate discharge conditions.

Barrier ribs 312 of a stripe form (or well form), for forming a plurality of discharge spaces (i.e., discharge cells), are arranged in parallel on the rear panel 310. Furthermore, the plurality of data electrodes 313, X, which generate vacuum ultraviolet rays by performing an address discharge, are disposed parallel to the barrier ribs 312. R, G and B phosphor layers 314 for emitting a visible ray for displaying images during the address discharge are coated on a top surface of the rear panel 310. A lower dielectric layer 315 for protecting the data electrodes 313, X is formed between the data electrodes 313, X and the phosphor layers 314.

There is shown in FIG. 3 only an example of the plasma display panel structure according to an embodiment of the present invention. It is, however, to be noted that the present invention is not limited to the structure of FIG. 3. For example, there is shown in FIG. 3 that the scan electrode 302, Y and the sustain electrode 303, Z are formed in the front panel 300, and the data electrodes 313, X are formed in the rear panel 310. However, all of the scan electrode 302, Y, the sustain electrode 303, Z and the data electrodes 313, X may be formed in the front panel 300.

Furthermore, it has been described above that each of the scan electrode 302, Y and the sustain electrode 303, Z comprises the transparent electrode (a) and the bus electrode (b). However, one or more of the scan electrode 302, Y and the sustain electrode 303, Z may comprise only the bus electrode (b).

The front panel 300 and the rear panel 310 formed as described above are coalesced through a sealing process, forming the plasma display panel. They are attached to the drivers for driving the electrodes as shown in FIG. 2, etc., thereby forming the plasma display apparatus.

Referring to FIG. 2, the second driver 122 is applied with data, which have experienced inverse gamma correction, error diffusion, etc. through an inverse gamma correction circuit (not shown), an error diffusion circuit (not shown), etc. and then mapped to respective subfields through a subfield mapping circuit. The second driver 122 samples and latches data and supplies the resulting data to the data electrodes X1 to Xm, in response to a timing control signal CTRX from the controller 121. A discharge cell (i.e., a cell in which a display discharge will be generated), which is turned on according to the data, is selected. For example, in the turned-on discharge cell, during an address period, the second driver 122 supplies data pulses to the data electrode X1 to Xm so that they are synchronized to scan pulses of a scan voltage −Vy, which are sequentially supplied to the scan electrodes Y1 to Yn from the first driver 123. A display discharge is generated in the turned-on discharge cell as a sustain pulse is supplied in a sustain period to be described later.

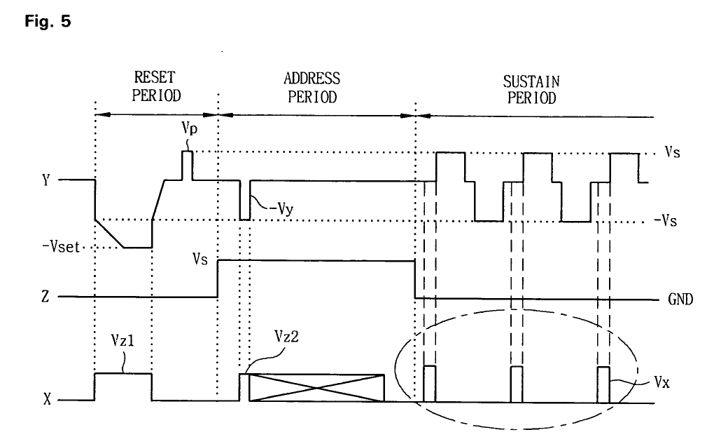

Furthermore, the second driver 122 according to an embodiment of the present invention may supply a positive voltage to the data electrode X anterior to an application point of time, of a positive sustain pulse to be described later, during the sustain period in order to prevent the image sticking. This will be described in detail later on with reference to FIG. 5.

The first driver 123 supplies a reset waveform to the scan electrode Y during the reset period under the control of the controller 121. Furthermore, the first driver 123 may sequentially supply the scan pulses of the scan voltage −Vy to the scan electrodes Y1 to Yn while sustaining the scan bias voltage Vsc during the address period under the control of the controller 121.

The first driver 123 can supply a bias voltage of a positive voltage to the sustain electrodes Z during a set-down period or a set-down period and the address period under the control of the controller 121.

Furthermore, the first driver 123 performs a sustain discharge by alternately supplying a positive sustain pulse and a negative sustain pulse to one of the sustaining electrodes (i.e., the scan electrode Y and the sustain electrode Z) during the sustain period under the control of the controller 121. At this time, as described above, in the plasma display apparatus of the present invention, the second driver 122 supplies a waveform of a positive voltage, which is sustained during a predetermined period, to the data electrodes anterior to the application point of time of the positive sustain pulse during the sustain period under the control of the controller 121. This will be described in detail later on with reference to the drawings subsequent to FIG. 5.

The controller 121 receives vertical/horizontal sync signals and a clock signal, generates timing control signals CTRX, CTRY and CTRZ for controlling an operating timing and synchronization of the respective drivers 122 and 123 in the reset period, the address period and the sustain period, and provides the generated timing control signals CTRX, CTRY and CTRZ to corresponding drivers 122 and 123, thereby controlling the respective drivers 122 and 123.

Meanwhile, the data control signal CTRX comprises a sampling clock for sampling data, a latch control signal, and a switching control signal for controlling an on/off time of a sustain driving circuit and a driving switch element. The scan control signal CTRY comprises a switching control signal for controlling an on/off time of a sustain driving circuit and a driving switch element within the first driver 123. The sustain control signal CTRZ comprises a switching control signal for controlling an on/off time of a sustain driving circuit and a driving switch element within the first driver 123.

The controller 121 constructed above according to the present invention controls the second driver 122 to supply a waveform of a positive voltage during a predetermined period in the reset period and the sustain period unlike the prior art. This will be described in detail later on with reference to the drawings following FIG. 5.

The driving voltage generator 124 generates a set-up voltage, a scan common voltage Vsc, a scan voltage −Vy, a sustain voltage Vs, a data voltage Va and the like. These driving voltages may be varied depending on the composition of a discharge gas, the structure of a discharge cell and/or the like.

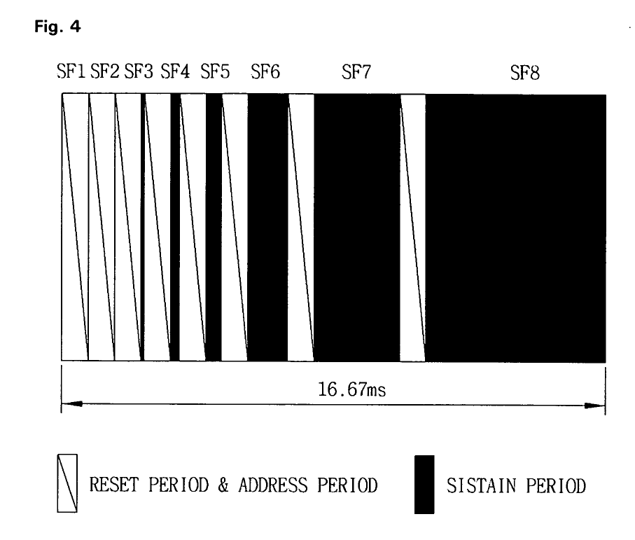

FIG. 4 is a view illustrating a method of implementing image gray levels of the plasma display apparatus according to an embodiment of the present invention.

Referring to FIG. 4, in the method of implementing gray levels of an image in the plasma display apparatus of the present invention, one frame is divided into several subfields each of which has an emission number set to a given value. Each of the subfields is again divided into a reset period for resetting the entire cells, an address period for selecting a cell to be discharged, and a sustain period for implementing gray levels depending on a discharge number.

For example, if it is sought to display an image with 256 gray levels, a frame period (16.67 ms) corresponding to 1/60 seconds is divided into eight subfields SF1 to SF8, as shown in FIG. 4. Each of the eight subfields SF1 to SF8 is again divided into the reset period, the address period, and the sustain period.

The reset period and the address period of each subfield are the same every subfield. Furthermore, the sustain period is increased in the ratio of 2ₙ (where n =0, 1, 2, 3, 4, 5, 6, 7) in each subfield. As described above, an image is displayed by employing a difference in the sustain period in each subfield. Gray levels of an image are represented by controlling the sustain period of each subfield (that is, a sustain discharge number).

An example in which one frame comprises eight subfields has been described above with reference to FIG. 4. It is, however, to be understood that the number of subfields constituting one frame may differ in various ways. For example, one frame may comprise twelve subfields from a first subfield to a twelfth subfield, ten subfields or the like.

It has also been shown in FIG. 4 that the subfields are arranged in order of increasing gray level weights in one frame. It is, however, to be noted that the subfields may be arranged in order of decreasing gray level weights or may be arranged irrespective of gray level weights in one frame.

Embodiments of driving waveforms in the driving method of the plasma display apparatus according to the present invention will be described below with reference to the drawing following FIG. 5.

FIG. 5 illustrates a first embodiment of a driving waveform in the driving method of the plasma display apparatus according to the present invention.

Referring to FIG. 5, the plasma display apparatus according to an embodiment of the present invention may be driven in such a manner that a frame of a screen is divided into a plurality of subfields, and each of the subfields is divided into a reset period for resetting the entire cells, an address period for selecting a cell to be discharged, and a sustain period for sustaining the discharge of a selected cell. Furthermore, an erase period for erasing wall charges within a discharged cell may be added and driven, if appropriate.

In the reset period, a negative reset pulse −Vset is supplied to the scan electrode Y. The reset pulse −Vset causes a weak dark discharge to occur in the discharge cells of the whole screen. The discharge causes negative wall charges to be accumulated on the data electrode X and the sustain electrode Z and positive wall charges to be accumulated on the scan electrode. Subsequently, the discharge erases wall charges, which have been excessively formed on the scan electrode, sufficiently. The reset discharge causes wall charges to uniformly remain within the cells to the extent that an address discharge can occur stably.

The negative reset pulse −Vset serves more effectively in the plasma display apparatus of the present invention. In other words, the negative reset pulse −Vset causes positive ions to be attracted toward electrodes opposite to the phosphors, thereby minimizing damage to the phosphors and prevent the image sticking.

Furthermore, the second driver 122 supplies a waveform of a positive voltage Vz1 to the data electrode X while the negative reset pulse −Vset is supplied to the scan electrode Y in the reset period under the control of the controller 121. Accordingly, not only damage to phosphors can be prevented effectively, but also the image sticking can be eliminated. In addition, there is an advantage in that lower-voltage driving is possible since a voltage of the negative reset pulse supplied to the scan electrode Y can be lowered relatively.

Furthermore, a positive narrow-width pulse Vp is supplied to a sustaining electrode to which the reset pulse has been supplied, such as the scan electrode Y, anterior to the address period after the negative reset pulse in the reset period is supplied, thus improving the accuracy of the address discharge. It is therefore possible to improve address margin. In addition, a larger number of negative wall charges are formed on the part of the scan electrode Y. Accordingly, wall charges can be controlled sufficiently although an absolute value of the negative scan pulse −Vy supplied to the scan electrode Y in the address period is low, thereby enabling lower-voltage driving. For example, the voltage of the negative scan pulse −Vy can be made the same as the voltage −Vs of the negative sustain pulse. By lowering the peak value as described above, the effect on phosphors can be reduced and the image sticking can be prevented more effectively.

In a next address period, while the negative scan pulse −Vy is supplied to the scan electrodes Y, a positive voltage Vz2 is supplied to the data electrode X in synchronization with the negative scan pulse −Vy. As a voltage difference between the negative scan pulse −Vy and the positive voltage Vz2 and a wall voltage generated in the reset period are added, an address discharge is generated in a discharge cell to which the positive voltage Vz2 is supplied. Wall charges of the degree that a discharge can occur when the sustain voltage Vs is supplied are formed within cells selected by the address discharge. The address discharge is generated by, for example, the above positive voltage Vz2. In other words, the negative scan pulse −Vy is sequentially supplied to the entire discharge cells, but the positive voltage Vz2 is supplied to only discharge cells in which a sustain discharge (i.e., display discharge) will be generated. It is therefore possible to select discharge cells to be turned on.

In the sustain period, a voltage Vs of a positive sustain pulse and a voltage −Vs of a negative sustain pulse are alternately supplied to one of the sustaining electrodes (that is, the scan electrode Y or the sustain electrode Z), thus performing a sustain discharge. At this time, in a cell selected by the address discharge, a sustain discharge (that is, a display discharge) is generated between the scan electrode and the sustain electrode whenever a sustain pulse is supplied as the wall voltage within the cell and the sustain pulse are added.

It has been shown in FIG. 5 that the sustaining electrode to which the positive sustain pulse and the negative sustain pulse are supplied is the scan electrode Y. However, the sustaining electrode is not limited to the scan electrode Y, but may include the sustain electrode Z. Furthermore, the other of the scan electrode Y and the sustain electrode Z to which the positive sustain pulse and the negative sustain pulse are not supplied in the sustain period (that is, the sustain electrode Z in FIG. 5) may be sustained to a ground level voltage GND.

If the erase period for erasing wall charges within the cell is added and driven after the sustain discharge is completed, a voltage of an erase ramp waveform Ramp-ers, which has a narrow pulse width or a low voltage level, is supplied to the sustain electrode in the erase period. Accordingly, wall charges remaining within cells of the whole screen can be erased.

Furthermore, in the plasma display apparatus of the present invention, the second driver 122 may supply a positive voltage, which is sustained for a predetermined period, to the data electrode X anterior to the application point of time of the positive sustain pulse Vs in the sustain period under the control of the controller 121.

In more detail, in the first embodiment of the present invention, a rising point of time, of a waveform of a positive voltage Vx supplied to the data electrode X, may be anterior to the positive sustain pulse Vs supplied to the sustaining electrode Y, and a falling point of time thereof may be the same as the application point of time of the positive sustain pulse Vs or may be anterior to the application point of time of the positive sustain pulse Vs. For example, in FIG. 5, the positive voltage Vx may be supplied to the data electrode X prior to the application point of time of the positive sustain pulse Vs, and the application of the positive voltage Vx to the data electrode X may be stopped at the application point of time of the positive sustain pulse Vs in order to prevent the image sticking. In other words, when the sustain discharge is generated by supplying the positive sustain pulse and the negative sustain pulse to only one electrode, a counter discharge with an electrode on the part of the panel in which the phosphors are formed (for example, the data electrode X) can be minimized. Accordingly, not only a sustain discharge characteristic can be improved, but also the effect on the phosphors can be reduced.

Furthermore, the positive voltage Vx is supplied to the data electrode X before the positive sustain pulse Vs is supplied to the sustaining electrode (for example, the scan electrode Y). It is therefore possible to prevent positive ions from being attracted toward the data electrode X in which the phosphors are formed. Accordingly, there are advantages in that the lifespan of the phosphors can be extended and the image sticking can be reduced.

Furthermore, if the negative sustain pulse −Vs is supplied to the sustaining electrode (for example, the scan electrode Y), negative ions or electrons are relatively attracted toward the phosphors. At this time, the phosphors that emit light with ultraviolet rays generated by the excitation of electrons are influenced by the electrons relatively greatly. Accordingly, the emission ability can be enhanced and luminance can be improved. It is therefore possible to improve the driving efficiency of the plasma display apparatus.

In this case, the positive sustain pulse and the negative sustain pulse that are supplied alternately in the sustain period may also be supplied to the scan electrode Y or the sustain electrode Z, as described above. For example, the positive sustain pulse and the negative sustain pulse may be alternately supplied to the scan electrode Y for supplying the driving waveform of the reset period (i.e., a negative ramp waveform) in order to integrate the drivers. However, one of the scan electrode and the sustain electrode to which the positive sustain pulse and the negative sustain pulse are not supplied may be sustained to the voltage of the ground (GND) level in order to stabilize a voltage level of a pulse supplied to the other of the scan electrode and the sustain electrode. Accordingly, a sustain discharge can be stabilized since the effect of noise or the influence of electronic wave can be minimized.

Furthermore, an absolute value of the voltage of the positive sustain pulse and an absolute value of the voltage of the negative sustain pulse may be set in the same manner as the sustain voltage Vs in order to simply the driving.

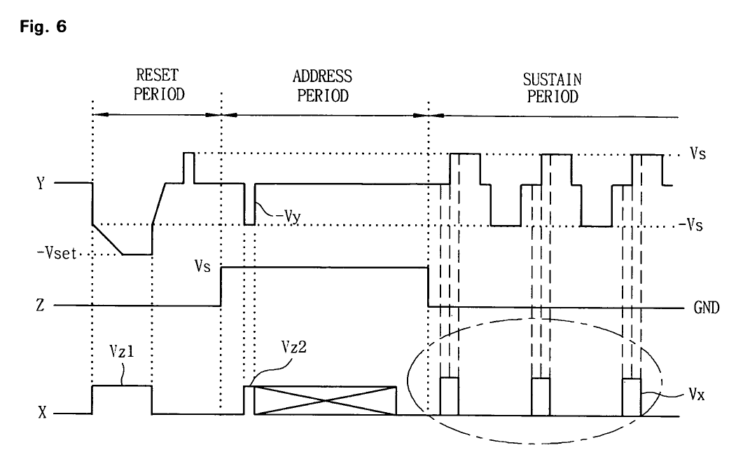

As described above, the present invention is advantageous in that it can extend the lifespan of phosphors and can prevent the image sticking. It is, however, to be noted that the present invention is not limited to the construction of the first embodiment. In other words, to prevent positive ions from being attracted toward the phosphors, a pulse supplied to the data electrode may be implemented in various ways. Another embodiment of the first embodiment will be described below with reference to FIG. 6.

FIG. 6 illustrates a second embodiment of a driving waveform in the driving method of the plasma display apparatus according to the present invention.

As shown in FIG. 6, in the same manner as the driving waveform of FIG. 5, the plasma display apparatus according to an embodiment of the present invention may be driven in such a manner that a frame of a screen is divided into a plurality of subfields, and each of the subfields is divided into a reset period for resetting the entire cells, an address period for selecting a cell to be discharged, and a sustain period for sustaining the discharge of a selected cell. Furthermore, an erase period for erasing wall charges within a discharged cell may be added and driven, if appropriate.

In this case, the reset period and the address period are the same as those that have been described with reference to FIG. 5 and, therefore, will not be described for simplicity. In the second embodiment of the present invention, when the sustain discharge is performed by alternately supplying positive sustain pulses and negative sustain pulses to one of the sustaining electrodes (that is, the scan electrode Y or the sustain electrode Z) in the sustain period, the second driver 122 may supply a positive voltage Vx to the data electrode X anterior to an supplication point of time of a positive sustain pulse Vs and may stop the application of the positive voltage Vx to the data electrode X while the positive sustain pulse is sustained to the sustain voltage Vs, in the sustain period under the control of the controller 121.

In other words, in the second embodiment of the present invention, a rising point of time, of a waveform of the positive voltage Vx supplied to the data electrode X, may be before the positive sustain pulse is supplied to the sustaining electrode Y, and a falling point of time thereof may be while the positive sustain pulse is sustained to the sustain voltage Vs. It is therefore possible to reduce the loss of phosphors and to effectively prevent the image sticking.

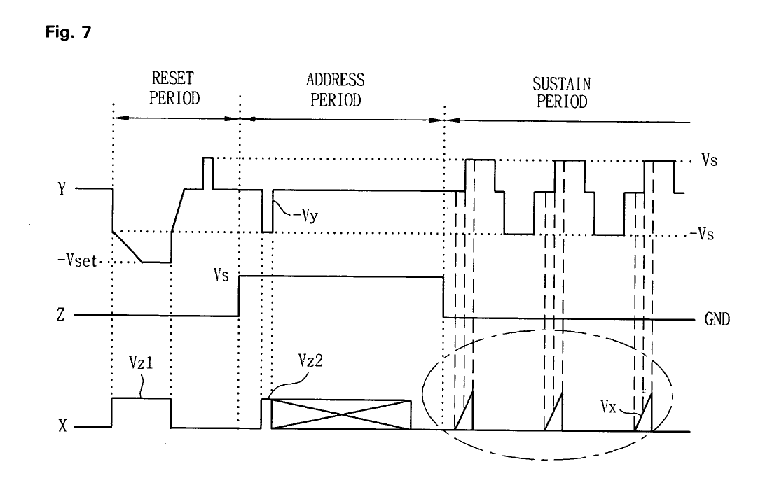

Hereinafter, a third embodiment different from the second embodiment will be described with reference to FIG. 7.

FIG. 7 illustrates a third embodiment of a driving waveform in the driving method of the plasma display apparatus according to the present invention.

As shown in FIG. 7, in the same manner as the driving waveform of FIG. 5, the plasma display apparatus according to an embodiment of the present invention may be driven in such a manner that a frame of a screen is divided into a plurality of subfields, and each of the subfields is divided into a reset period for resetting the entire cells, an address period for selecting a cell to be discharged, and a sustain period for sustaining the discharge of a selected cell. Furthermore, an erase period for erasing wall charges within a discharged cell may be added and driven, if needed.

In this case, the reset period and the address period are the same as those that have been described with reference to FIG. 5 and, therefore, will not be described for simplicity. In the third embodiment of the present invention, when the sustain discharge is performed by alternately supplying positive sustain pulses and negative sustain pulses to one of the sustaining electrodes (that is, the scan electrode Y or the sustain electrode Z) in the sustain period, the second driver 122 may supply a positive voltage Vx to the data electrode X anterior to an application point of time of a positive sustain pulse Vs and may stop the application of the positive voltage Vx to the data electrode X while the positive sustain pulse is sustained to the sustain voltage Vs, in the sustain period under the control of the controller 121.

In this case, in the third embodiment of the present invention, a waveform of a positive voltage Vx supplied to the data electrode X may rise at a predetermined slope. In other words, the waveform of the positive voltage Vx may rise at a predetermined slope before the positive sustain pulse is supplied and may fall during a period in which the positive sustain pulse is sustained to the sustain voltage Vs, as shown in FIG. 7. Accordingly, damage to phosphors due to positive ions and the image sticking can be prevented effectively.

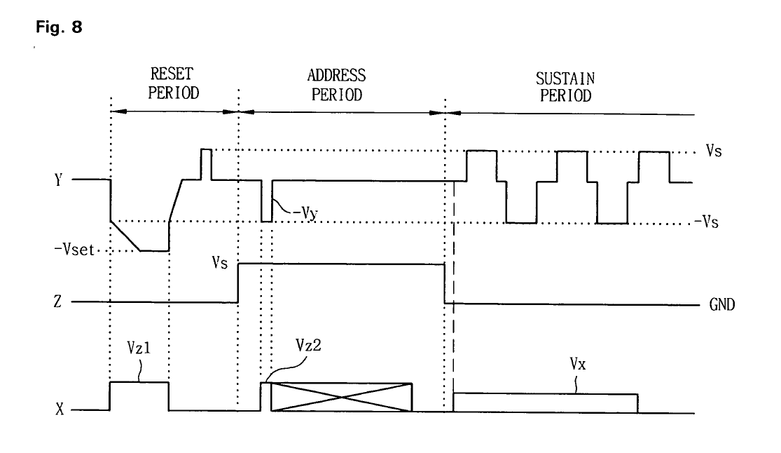

FIG. 8 illustrates a fourth embodiment of a driving waveform in the driving method of the plasma display apparatus according to the present invention.

As shown in FIG. 8, in the same manner as the driving waveform of FIG. 5, the plasma display apparatus according to an embodiment of the present invention may be driven in such a manner that a frame of a screen is divided into a plurality of subfields, and each of the subfields is divided into a reset period for resetting the entire cells, an address period for selecting a cell to be discharged, and a sustain period for sustaining the discharge of a selected cell. Furthermore, an erase period for erasing wall charges within a discharged cell may be added and driven, if needed.

In this case, the reset period and the address period are the same as those that have been described with reference to FIG. 5 and, therefore, will not be described for simplicity. In the fourth embodiment of the present invention, when the sustain discharge is performed by alternately supplying positive sustain pulses and negative sustain pulses to one of the sustaining electrodes (that is, the scan electrode Y or the sustain electrode Z) in the sustain period, the second driver 122 may supply a positive voltage Vx to the data electrode X anterior to an application point of time of a positive sustain pulse Vs and may cause the positive voltage Vx to be sustained for a redetermined period in the sustain period, in the sustain period under the control of the controller 121.

In the fourth embodiment of the present invention, the waveform of the positive voltage Vx supplied to the data electrode X can be kept to a voltage level during the sustain period. In other words, as shown in FIG. 8, for example, a positive voltage lower than the sustain voltage Vs may be kept during the sustain period in order to effectively prevent positive ions from being attracted.

As described above, embodiments of the present invention are not limited to the above embodiments. That is, if damage to phosphors due to positive ions can be prevented by supplying the positive sustain pulse and the negative sustain pulse to the sustaining electrode and supplying a waveform to the data electrode before the positive sustain pulse is supplied in the sustain period, it is considered to fall within the scope of the present invention. Accordingly, the waveform supplied to the data electrode may be implemented in various ways, such as a DC voltage, a bias voltage having a slope, and a ramp pulse.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus, comprising:
a plasma display panel comprising a sustaining electrode and a data electrode intersecting the sustaining electrode;
a first driver for supplying a positive sustain pulse and a negative sustain pulse to the sustaining electrode in a sustain period; and
a second driver for supplying a positive voltage to the data electrode prior to an application point of time of the positive sustain pulse.

2. The plasma display apparatus of claim 1, wherein the sustaining electrode comprises either a scan electrode or a sustain electrode.

3. The plasma display apparatus of claim 2, wherein the first driver causes a ground level voltage to be sustained in either the scan electrode or the sustain electrode, to which the positive sustain pulse and the negative sustain pulse are not supplied in the sustain period.

4. The plasma display apparatus of claim 1, wherein the second driver sustains the positive voltage, which is supplied to the data electrode, at a predetermined voltage level during the sustain period.

5. The plasma display apparatus of claim 1, wherein the first driver supplies a negative reset pulse to the sustaining electrode in a reset period.

6. The plasma display apparatus of claim 5, wherein the second driver supplies the positive voltage to the data electrode while the negative reset pulse is supplied to the sustaining electrode.

7. The plasma display apparatus of claim 5, wherein the first driver supplies a positive narrow-width pulse to the sustaining electrode prior to an address period after the negative reset pulse is supplied.

8. A plasma display apparatus, comprising:
a plasma display panel comprising a sustaining electrode and a data electrode intersecting the sustaining electrode;
a first driver for supplying a positive sustain pulse and a negative sustain pulse to the sustaining electrode in a sustain period; and
a second driver for supplying a positive voltage to the data electrode prior to an application point of time of the positive sustain pulse, and stopping the application of the positive voltage to the data electrode at an application point of time of the positive sustain pulse or prior to an application point of the positive sustain pulse time.

9. The plasma display apparatus of claim 8, wherein the sustaining electrode comprises either a scan electrode or a sustain electrode.

10. The plasma display apparatus of claim 9, wherein the first driver causes a ground level voltage to be sustained in either the scan electrode or the sustain electrode, to which the positive sustain pulse and the negative sustain pulse are not supplied in the sustain period.

11. The plasma display apparatus of claim 8, wherein the first driver supplies a negative reset pulse to the sustaining electrode in a reset period.

12. The plasma display apparatus of claim 11, wherein the second driver supplies the positive voltage to the data electrode while the negative reset pulse is supplied to the sustaining electrode.

13. The plasma display apparatus of claim 11, wherein the first driver supplies a positive narrow-width pulse to the sustaining electrode prior to an address period after the negative reset pulse is supplied.

14. A plasma display apparatus, comprising:
a plasma display panel comprising a sustaining electrode and a data electrode intersecting the sustaining electrode;
a first driver for supplying a positive sustain pulse and a negative sustain pulse to the sustaining electrode in a sustain period; and
a second driver for supplying a positive voltage to the data electrode prior to an application point of time of the positive sustain pulse, and stopping the application of the positive voltage while the positive sustain pulse is sustained at a sustain voltage.

15. The plasma display apparatus of claim 14, wherein the second driver causes the positive voltage, which is supplied to the data electrode, to rise at a predetermined slope.

16. The plasma display apparatus of claim 14, wherein the sustaining electrode comprises either a scan electrode or a sustain electrode.

17. The plasma display apparatus of claim 16, wherein the first driver causes a ground level voltage to be sustained in either the scan electrode and the sustain electrode, to which the positive sustain pulse and the negative sustain pulse are not supplied in the sustain period.

18. The plasma display apparatus of claim 14, wherein the first driver supplies a negative reset pulse to the sustaining electrode in a reset period.

19. The plasma display apparatus of claim 18, wherein the second driver supplies the positive voltage to the data electrode while the negative reset pulse is supplied to the sustaining electrode.

20. The plasma display apparatus of claim 18, wherein the first driver supplies a positive narrow-width pulse to the sustaining electrode prior to an address period after the negative reset pulse is supplied.
